(19) United States
(12) Patent Application Publication
(10) Pub. No.: US 2005/0126190 A1
(43) Pub. Date: Jun. 16, 2005

(54) Loss of refrigerant charge and expansion valve malfunction detection

(76) Inventors: Alexander Lifson, Manlius, NY (US); Michael F. Taras, Fayetteville, NY (US); Thomas J. Dobmeier, Phoenix, NY (US)

Correspondence Address: CARLSON, GASKEY & OLDS, P.C., 400 WEST MAPLE ROAD, SUITE 350, BIRMINGHAM, MI, 48009, US

(21) Appl. No.: 10/732,134

(22) Filed: Dec. 10, 2003

(51) Int. Cl. G01K 13/00; F25B 45/00

(52) U.S. Cl. 62/129; 62/149

(57) ABSTRACT

An actual superheat value in a refrigerant system is compared to an expected superheat level. If the actual superheat valve exceeds a certain predetermined value, this is an indication of refrigerant charge loss or a malfunctioning expansion device. In one example, the superheat valve is determined by comparing a difference between a saturated vapor temperature and an actual operating vapor temperature. The superheat determination can be made either at evaporator exit, economizer heat exchange exit or near the compressor discharge port.

### BACKGROUND OF THE INVENTION

1. Field of the Invention

This invention generally relates to air conditioning and refrigeration systems. More particularly, this invention relates to detecting a loss of refrigerant charge within an air conditioning or refrigeration system. Furthermore, this invention can also be employed for identifying malfunctioning of the expansion valve.

2. Description of the Related Art

Air conditioning and refrigeration systems need certain refrigerant charge within the system, to achieve a desired amount of cooling within a building, for example. If the refrigerant charge is reduced below a certain level, damage to the system components, such as the compressor, is likely.

Typical causes of inadequate refrigerant charge amounts include insufficient charge at the factory or during installation in the field or leakage through damaged components or loose connections.

It is necessary to detect a loss of refrigerant charge as early as possible to avoid interrupting system operation, especially during high ambient temperature conditions, when adequate cooling at full-load operation is essential to end users. It is also prudent and critical to diagnose a malfunctioning expansion valve as early as possible to avoid system component damage.

While proposals have been made for detecting a loss of refrigerant charge, they are not universally applicable. Further, known arrangements do not provide an early enough indication or are not reliable enough because they can be mistaken for some other system malfunctions such as an evaporator airflow blockage, compressor damage or a plugged distributor. Using known techniques and trying to differentiate between such failure modes requires exhaustive troubleshooting. Furthermore, other consequences of the refrigerant charge loss, such as detection of low suction pressure (i.e., by tripping on a low-pressure switch), usually occur late in the process and applying them may not prevent compressor damage.

In addition, the need for detecting refrigerant charge loss becomes especially acute with the introduction of systems that utilize high pressure refrigerants as R410A and R744. Systems with these refrigerants are more prone to leaks.

Furthermore, expansion valves in refrigerant systems may malfunction (for example, due to contamination). This in turn may lead to improper system operation and other component damage. Timely detection of such problems is useful to prevent extensive damage and to reduce maintenance.

This invention provides a unique early detection of refrigerant charge loss or expansion valve malfunction in the system. The disclosed techniques are useful to prevent compressor damage and to avoid prolonged shutdowns and expensive repairs.

### SUMMARY OF THE INVENTION

This invention utilizes information regarding a superheat value within a refrigerant system for monitoring an amount of refrigerant charge in the system.

One method includes determining a refrigerant superheat value within the refrigerant system. By determining a difference between the measured superheat value and an expected superheat value and comparing that difference to a selected threshold, a loss of refrigerant charge can be monitored.

One example method includes determining the superheat value based on an actual operating vapor temperature and a saturated vapor temperature. The difference between the saturated vapor temperature and the actual operating vapor temperature is the superheat value.

In one example, the method includes determining a superheat value of refrigerant between the compressor and evaporator coil. In another example, the refrigerant system includes an economizer heat exchanger and an evaporator heat exchanger. In this example, the method includes determining superheat value of the refrigerant between the compressor and the evaporator coil or between the compressor and the economizer heat exchanger.

In another example, a discharge temperature of refrigerant exiting the compressor is determined to provide a confirmation check on the determined superheat value(s). Using known relationships between the superheat value(s) and the discharge temperature provides the ability to verify the superheat information and, therefore, to determine if refrigerant loss of charge occurs within the system. Similar procedures and techniques are useful to identify a malfunctioning expansion valve.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a refrigerant system designed according to an embodiment of this invention.

FIG. 2 schematically illustrates another refrigerant system designed according to another embodiment of this invention.

### DETAILED DESCRIPTION OF THE PREFERRED EMBODIMENT

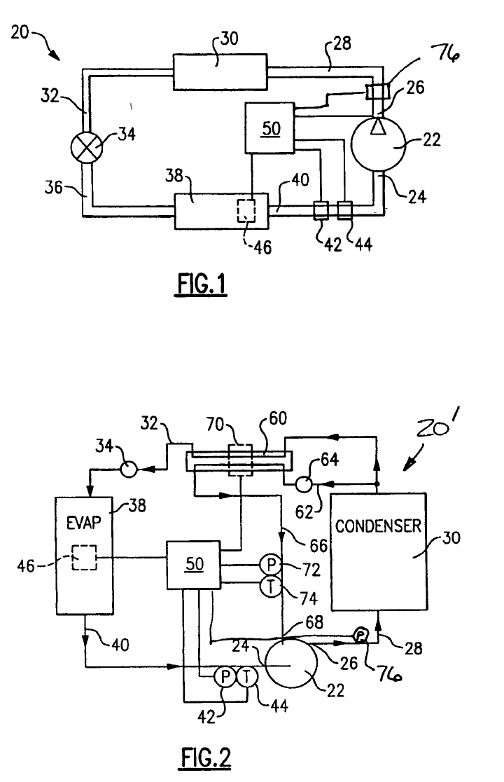

FIG. 1 schematically shows a refrigerant system 20 that may be used as an air conditioning or a refrigeration system. In a cooling mode, a compressor 22 draws refrigerant into a suction port 24 at low pressure and provides a compressed gas into a conduit 28 out of a discharge port 26. The high temperature, pressurized gas flows through the conduit 28 to a condenser 30 where the gas dissipates heat and usually condenses into a liquid as known. The liquid refrigerant flows through a conduit 32 to an expansion device 34.

The expansion device 34 operates in a known manner to allow the liquid refrigerant to expand and flow into a conduit 36 in the form of a cold, low pressure refrigerant. This refrigerant then flows through an evaporator 38 where the refrigerant absorbs heat from air that flows across the evaporator coil. Subsequently, cool air cools the desired space as known. The refrigerant exiting the evaporator 38 flows through a conduit 40 to the suction port 24 of the compressor 22 where the cycle continues. In one example, the system 20 may also be used as a heat pump where the just-described flow is reversed as known. Some example systems operate in both modes as known and can be utilized as well.

In the example of FIG. 1, sensors 42, 44 and 46 provide information to a controller 50 regarding superheat values within the system 20 such that the controller 50 is capable of making a determination regarding the amount of refrigerant within the system. The amount of superheat is set at a constant (or near constant) value by the expansion valve(s) 34. When the loss of charge occurs, the expansion valve opens fully to compensate for loss of charge to allow more refrigerant to go through. After enough refrigerant is lost, the expansion valve cannot open any farther to maintain the required superheat. If this occurrence can be detected, then appropriate corrective actions can be taken to fix the problem prior to compressor/system extensive damage.

The embodiment of FIG. 1 includes a temperature sensor 42, such as a known transducer and a pressure sensor 44, such as a known transducer, located either within the conduit 40 between the evaporator 38 and the suction port 24 of the compressor 22 or within the evaporator coil 38. Accordingly, the controller 50 receives temperature and pressure information regarding the refrigerant in the low pressure side of the system and more particularly, the refrigerant that is entering the compressor 22 or leaving the evaporator coil 38 or anywhere in between of these two locations.

The controller 50 determines the amount of superheat by subtracting a saturated vapor temperature from the actual operating vapor temperature, which is the temperature of the refrigerant normally determined in the line located between the compressor entrance and exit from the evaporator heat exchanger. The actual operating vapor temperature in FIG. 1 is provided to the controller 50 by the temperature sensor 42, which is placed downstream of the evaporator heat exchanger 38. In this example, instead of using pressure sensor 44, the saturated vapor temperature is determined from the temperature sensor 46 placed inside the evaporator heat exchanger, preferably in the mid-section of the evaporator coil, in one example.

The refrigerant system will normally operate within an acceptable superheat level or range of levels. The controller 50 in this example is programmed to determine a difference between the determined superheat (i.e., based upon the difference between the saturated vapor temperature and the actual operating vapor temperature) and the expected superheat level. When the difference exceeds a selected threshold, the controller 50 determines that the amount of refrigerant within the system is too low.

In another example, the controller monitors the superheat level over time to determine changes in the superheat value. In this embodiment, the controller 50 uses known or predicted temperature patterns and is capable of determining when the superheat value begins increasing as a result of the expansion device 34 not being able to open any further to maintain the required superheat levels. The example arrangements are capable of providing an early indication of low refrigerant amount such that appropriate corrective action can be taken to avoid any potential compressor and system damage.

FIG. 2 illustrates another example embodiment of a refrigerant system 20′ that has a controller 50 that determines the superheat level within the system for purposes of detecting loss of refrigerant charge within the system. This example system operates similar to that of the embodiment of FIG. 1 with the addition of an economizer heat exchanger 60 downstream of the condenser 30 and upstream of the expansion device 34. Economizer heat exchangers are generally known. In this example, main refrigerant flow passes through the economizer heat exchanger 60 and the conduit 32, after the condenser 30. Another conduit 62 includes an expansion device 64 and is coupled with the economizer heat exchanger 60. The refrigerant flowing through the conduit 62 and the economizer heat exchanger effectively absorbs heat from refrigerant flowing through the main conduit 32 before that refrigerant reaches the expansion device 34. Accordingly, the economizer heat exchanger 60 provides further cooling of the main refrigerant flow prior to it reaching the expansion device 34.

A conduit 66 carries refrigerant from the economizer heat exchanger 60 to another inlet economizer port 68 of the compressor 22 at some intermediate pressure. In this example, a pressure sensor 72 and a temperature sensor 74 are associated with the conduit 66 to provide pressure and temperature information to the controller 50 regarding the refrigerant entering the compressor economizer port 68.

The superheat value of refrigerant in the section between the economizer heat exchanger 60 and the economizer port 68 of the compressor 22 is determined using sensors 70, 72 and 74 in a fashion similar to the way sensors 42, 44 and 46 are applied in the embodiment of this invention shown in FIG. 1.

Like the embodiment of FIG. 1, the controller 50 determines the superheat value in the system 20′ and compares that to an expected superheat value. When a difference between the determined superheat and the expected superheat exceeds a selected threshold, the controller 50 determines that the amount of refrigerant in the system is too low.

Given this description, those skilled in the art will be able to determine how to select an appropriate threshold for a particular system arrangement and a particular refrigerant used in that system.

The inventive arrangement not only provides an indication of potentially reduced refrigerant amount, but also provides the ability to determine if the expansion device 34 or 64 is malfunctioning. As noted above, when the superheat is increasing above a predetermined value, that is an indication that the expansion device cannot open any further to maintain the expected superheat level. It is possible under some circumstances for the expansion device 34 or 64 to be malfunctioning and not opening wide enough to accommodate the desired condition. Accordingly, the determination made by the controller 50 provides an indication of a potential expansion device malfunction.

When the controller 50 determines that the superheat value is outside of the expected range, in one example, the controller provides a visual indication on a display screen. In another example, the controller provides an audible alarm or audible signal regarding the determination that the refrigerant amount is too low.

In another example, the controller 50 automatically shuts down the system and provides the indication regarding the reason for the shutdown.

In the embodiments of FIG. 1 and FIG. 2, the controller 50 can use an additional check on the refrigerant amount within the system by determining a discharge temperature associated with the compressor 22. When the system is operating properly, the expected discharge temperature can be determined based upon information from the sensors 42, 44, 72 and 74 regarding pressure and temperature of refrigerant entering the compressor and discharge pressure sensor 76, for instance. The compressor discharge temperature also can be determined by the controller 50 using known techniques. The compressor discharge temperature is a function of the pressure and temperature entering the compressor and the discharge pressure of the compressor. If the vapor temperature entering the compressor exceeds the preset superheat value, this will result in an increase in discharge temperature above the value that was expected if the entering superheat was within the preset limits. Accordingly, determining any difference between the expected and actual value of the discharge temperature provides a confirmation of the superheat information determined by the controller 50.

It should be noted the previous description would apply to a case of multiple evaporator heat exchangers, multiple economizer heat exchangers or both. In this case the refrigerant superheat can be analyzed independently for each evaporator or economizer heat exchanger section to determine if there is a refrigerant charge loss or malfunctioning expansion valve.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of determining loss of refrigerant charge in a refrigerant system, comprising:
automatically determining a superheat value; and
determining if a difference between the determined superheat value and an expected superheat value exceeds a selected threshold.

2. The method of claim 1, including determining the superheat value by determining an actual operating vapor temperature, a saturated vapor temperature and determining a difference between the saturated temperature and the operating temperature as the superheat value.

3. The method of claim 2, wherein the refrigerant system includes a compressor and at least one evaporator heat exchanger and including determining the actual operating vapor temperature by determining a temperature of the refrigerant between the compressor and the at least one evaporator heat exchanger.

4. The method of claim 3, wherein the refrigerant system includes an economizer heat exchanger and including determining the actual operating vapor temperature by determining a temperature of the refrigerant between the compressor and at least one of the economizer heat exchanger or at least one evaporator heat exchanger.

5. The method of claim 2, wherein the refrigerant system includes at least one evaporator heat exchanger and the method includes determining the saturated vapor temperature by determining a vapor temperature within the at least one evaporator heat exchanger.

6. The method of claim 2, wherein the refrigerant system includes an economizer heat exchanger and the method includes determining the saturated vapor temperature by determining a vapor temperature within at least one of the economizer heat exchanger or the at least one evaporator heat exchanger.

7. The method of claim 1, including determining that the amount of refrigerant is below a desired amount when the determined difference exceeds the selected threshold.

8. The method of claim 1, wherein the refrigerant system includes a compressor and the method includes determining a discharge temperature of refrigerant exiting the compressor.

9. The method of claim 8, including using the determined discharge temperature as a confirmation of the determined superheat value.

10. A refrigerant system, comprising:
a controller that determines a superheat value within the system and determines if a difference between the determined superheat value and an expected superheat value exceeds a selected threshold.

11. The system of claim 10, wherein the controller determines that the amount of refrigerant is below a desired amount when the determined difference exceeds the selected threshold.

12. The system of claim 10, wherein the controller determines the superheat value by determining an actual operating vapor temperature, a saturated vapor temperature and a difference between the saturated temperature and the actual operating temperature as an indication of the superheat value.

13. The system of claim 12, including a compressor and at least one evaporator heat exchanger and wherein the controller determines the actual vapor temperature by determining a temperature of refrigerant between the compressor and said at least one evaporator heat exchanger.

14. The system of claim 13, including an economizer heat exchanger and wherein the controller determines the actual operating vapor temperature of the refrigerant entering the compressor at least one of the economizer heat exchanger or the at least one evaporator heat exchanger.

15. The system of claim 14, wherein the controller determines a discharge temperature of refrigerant exiting the compressor.

16. The system of claim 15, wherein the controller uses the determined discharge temperature as a confirmation of the determined superheat value based upon an expected relationship between the superheat value and the discharge temperature.

17. The system of claim 13, wherein the controller determines a discharge temperature of refrigerant exiting the compressor.

18. The system of claim 12, including an economizer heat exchanger and at least one evaporator heat exchanger and wherein the controller determines the saturated vapor temperature by determining a vapor temperature within at least one of the economizer heat exchanger or the at least one evaporator heat exchanger.

19. The system of claim 12, including at least one evaporator heat exchanger and wherein the controller determines the saturated vapor temperature by determining a vapor temperature within at the least one evaporator heat exchanger.

20. A method of detecting a malfunction of an expansion valve in a refrigerant system, comprising:
automatically determining a superheat value; and
determining if a difference between the determined superheat value and an expected superheat value exceeds a selected threshold.
